(19) United States
(12) Patent Application Publication
(10) Pub. No.: US 2021/0235609 A1
(43) Pub. Date: Aug. 5, 2021

(54) SOIL ROUGHNESS SYSTEM AND METHOD

(71) Applicant: CNH Industrial America LLC, New Holland, PA (US)

(72) Inventor: Luca Ferrari, Formigine (Modena) (IT)

(21) Appl. No.: 17/048,651

(22) PCT Filed: Apr. 4, 2019
(86) PCT No.: PCT/EP2019/058553

§ 371 Date: Oct. 19, 2020

(30) Foreign Application Priority Data
Apr. 19, 2018 (BE) BE2018/0046

(51) Int. Cl. A01B 69/00; A01B 76/00; G01S 13/88; G01S 13/90; G01S 13/53; G01S 7/02

(52) U.S. Cl. CPC A01B 69/004; A01B 76/00; G01S 7/024; G01S 13/9076; G01S 13/53; G01S 13/885

(57) ABSTRACT

An agricultural machine includes a soil roughness system mounted to the machine. The soil roughness (SR) system includes at least one radar unit configured to emit signals, receive reflected signals, and generate radar signals. The reflected signals are the emitted signals reflected from a field. The SR system further includes a controller communicatively coupled to the at least one radar unit. The controller is configured to generate soil roughness values of the field based at least upon the radar signals. The controller or an operator of the machine may then adjust properties of an agricultural implement based upon the soil roughness values.

### BACKGROUND OF THE INVENTION

The present invention relates to agricultural systems and methods thereof, and more particularly, to soil roughness systems and methods thereof.

Agricultural machines may include agricultural vehicles which may or may not tow agricultural implements. For example, an agricultural vehicle in the form of a combine or sprayer typically includes a component thereof which at least somewhat interacts with the field over which it traverses (i.e., header in the case of a combine, or spray booms in the case of a sprayer). Other types of agricultural vehicles such as tractors typically are used to tow agricultural implements which are used to till and/or finish the soil for subsequent seeding operations, such as planting or drilling. Examples of tillage and finish implements include disks, disk/harrows, disk/finish drags, field cultivators, finish wheels, aka crumbler baskets, etc.

Depending on the type of subsequent agricultural operation, such as planting or drilling, it may be desirable to finish the soil to differing degrees of granularity or smoothness. In the case of a disk/finish drag, the implement can include a disk, spring tooth drag and finish wheel, and an experienced operator can adjust these various components individually to achieve a desired soil finish. However, if the operator is inexperienced, the operator may not really know what is a desired soil finish or the resultant soil finish may not be ideal. Moreover, agricultural vehicles are tending toward more and more automatic guidance and control of the vehicle, so visual observation of the soil finish and manual adjustment of the implement may not be possible.

U.S. Pat. No. 8,849,523 adjusts the planting depth of a planter, which is towed by an agricultural vehicle, based upon various intrinsic and extrinsic characteristics of the soil that are detected by a ground penetrating radar unit. The radar unit has a ground penetrating radar soil sensor that is mounted on an agricultural vehicle. The ground penetrating radar soil sensor scans the soil at a designated depth beneath a surface of the soil. The ground penetrating radar soil sensor may transmit unmodulated continuous-wave signals that are used to create a plan-view subsurface hologram of the soil. However, such ground penetrating radar units do not evaluate the soil after the implement has worked the soil, nor do they provide an adequate measurement of the surface of the soil.

EP 2,668,469 adjusts the operation of a ground-leveling implement based upon surface evenness data of the soil which is detected by a surface evenness sensor. The sensor comprises a pair of detectors mounted on the implement at separate locations for respectively measuring the distance between a top, ridge of a respective furrow and a bottom, floor of the furrow. The surface evenness of the soil is then calculated by taking the difference between top and bottom of the furrow. Each detector could be in the form of a transmitter that transmits radar, ultrasound or laser light and a receiver that receives radar, ultrasound and laser light. Yet, such differential top-to-bottom furrow measurement systems may be costly, offer inaccurate evenness interpretations, or have a limited applicability.

WO 2017/049186 uses a soil monitoring system with a sensor, mounted onto an implement, for detecting various soil criteria, such as surface residue, clod size, or soil shatter of the soil. The sensor may detect the soil before and/or after the soil is tilled by the implement, and the sensor may be in the form of a detection and ranging (LiDar) sensor, spectrophotometer, camera, time of flight camera, ground penetrating radar, sonar, x-ray, optical height, electrical conductivity, and electromagnetic induction. However, such ground penetrating radar systems may not accurately measure the surface of the soil.

JP HO8 292253 uses a radar device for measuring the structure difference of soil, e.g. surface roughness, or soil moisture, e.g. water content. The radar device may be in the form of a transmission antenna and a juxtaposed detection antenna which respectively send and receive a microwave. The device may then measure the microwave that is scattered from the measured surface or object via using a polarization rotating plate.

US 2013/332115 detects soil moisture via radio frequency (RF) polarization in order to monitor the field and optimize crop growth. The polarization device includes a transmitter that transmits a polarized signal at a certain depth into the soil, a polarized receiver, and a processor for eliciting a polarization mode dispersion (PMD) feature of the received polarized signal. Hence, the change in soil moisture may be determined by comparing the measured PMD features to a standard PMD feature.

What is needed in the art is a system and method that can overcome some of the disadvantages of known cultivation practices.

### SUMMARY OF THE INVENTION

The present invention is directed to a system and method which can automatically sense the roughness or finish of soil in a field, and potentially adjust the operating characteristics of an implement to adjust the soil finish to within acceptable limits.

In accordance with an aspect of the present invention, an agricultural machine includes an agricultural implement with a rear end and a soil roughness system mounted to the agricultural implement. The soil roughness (SR) system includes at least one radar unit configured to emit signals, receive reflected signals, and generate radar signals. The SR system is a Doppler radar unit or a polarimetric radar unit. The SR system is mounted onto the rear end of the agricultural implement. The SR system emits the emitted signals onto a surface of the field, behind the agricultural implement. The field comprises clods of soil. The reflected signals are the emitted signals reflected from the clods of soil in the field such that a change in said reflected signals relative to the emitted signals is caused by the clods of soil. The SR system further includes a controller communicatively coupled to the at least one radar unit. The controller is configured to generate soil roughness values of the field based at least upon the radar signals. More particularly, the controller generates soil roughness values of the field based at least upon the measured change between the emitted signals and the reflected signal; thus, indicating the size variation of the clods of soil in the surface of the field. The controller or an operator of the machine may then adjust properties of an agricultural implement based upon the soil roughness values.

According to another aspect of the invention, the at least one radar unit is a Doppler radar unit, and the radar signals are Doppler radar signals.

According to another aspect of the invention, the generated soil roughness values are based upon a standard deviation of the Doppler radar signals.

According to another aspect of the invention, the generated soil roughness values are based upon the Doppler radar signals, a speed of the agricultural machine relative to the field and a frequency of the emitted signals.

According to another aspect of the invention, the field includes clods of soil, and the generated soil roughness values are based upon the Doppler radar signals, a speed of the agricultural machine relative to the field, a frequency of the emitted signals, and one or more geometric parameters of an average clod of soil of the clods of soil.

According to another aspect of the invention, the at least one radar unit is a polarimetric radar unit.

According to another aspect of the invention, the radar signals represent a change in a polarization of the emitted signals and/or an energy difference between the emitted signals and the received reflected signals. The change in the polarization of the emitted signals is based at least upon a polarization distribution of the emitted signals and a polarization distribution of the received reflected signals.

According to another aspect of the invention, the polarization of the emitted signals is a circular polarization.

According to another aspect of the invention, the agricultural machine is an agricultural vehicle, wherein the agricultural vehicle further includes an output device communicatively coupled to the controller and an actuator control panel communicatively coupled to the controller and to one or more actuators of the agricultural implement coupled via a tow bar to the agricultural vehicle, wherein the output device is configured to receive and display the soil roughness values and the one or more actuators are configured for receiving control signals and adjusting the properties of the agricultural implement based on the received control signals. The actuator control panel is configured to generate the control signals via an operator of the vehicle based upon the soil roughness values.

According to another aspect of the invention, the controller further includes a memory and a processor configured to generate the soil roughness values based at least upon the radar signals, wherein the agricultural vehicle further includes an input device communicatively coupled to the controller, wherein the controller is configured to receive a predetermined desired soil roughness value via the input device, wherein the memory is configured to store the desired soil roughness, wherein the processor is further configured to compare the generated soil roughness values with the desired soil roughness value and generate electrical control signals based upon the comparison, and wherein the actuator control panel is further configured to receive the electrical control signals and generate additional control signals based upon the received electrical control signals.

According to another aspect of the invention, the agricultural machine is an agricultural implement, wherein the agricultural implement includes one or more actuators, wherein the agricultural implement is coupled to an agricultural vehicle via a tow bar, wherein the agricultural vehicle includes an output device and an actuator control panel, wherein the controller is communicatively coupled to the output device and the actuator control panel, wherein the output device is configured to receive and display the soil roughness values, and wherein the actuator control panel is communicatively coupled to the one or more actuators, wherein the one or more actuators are configured for receiving control signals and adjusting the properties of the agricultural implement based on the received control signals, and wherein the actuator control panel is configured to generate the control signals via an operator of the vehicle based upon the soil roughness values.

According to another aspect of the invention, the controller further includes a memory and a processor configured to generate the soil roughness values based at least upon the radar signals, wherein the agricultural vehicle further includes an input device communicatively coupled to the controller, wherein the controller is configured to receive a predetermined desired soil roughness value via the input device, wherein the memory is configured to store the desired soil roughness, wherein the processor is further configured to compare the generated soil roughness values with the desired soil roughness value and generate electrical control signals based upon the comparison, and wherein the actuator control panel is further configured to receive the electrical control signals and generate additional control signals based upon the received electrical control signals.

An advantage of the system described herein is to provide quantification of soil roughness values, thereby enabling farmers to correlate production with soil parameters and further enabling farmers to improve cultivation consistency via controlling properties of soil cultivation implements.

### BRIEF DESCRIPTION OF THE DRAWINGS

The above-mentioned and other features and advantages of this invention, and the manner of attaining them, will become more apparent and the invention will be better understood by reference to the following description of exemplary embodiments of the invention taken in conjunction with the accompanying drawings, wherein:

FIG. 1 is a perspective view of a system including an agricultural vehicle, an agricultural implement and a soil roughness system, formed in accordance with an embodiment of the present invention;

FIG. 2 is a perspective view of a system including an agricultural vehicle, an agricultural implement and a soil roughness system, formed in accordance with another embodiment of the present invention;

FIG. 3 shows components of the soil roughness system of FIGS. 1 and 2, formed in accordance with an embodiment of the present invention;

FIG. 4 shows soil roughness measured as a geometric parameter θ of a clod, according to one embodiment of the invention; and

FIG. 5 is a flow chart illustrating an exemplary method performed by the soil roughness system of FIG. 3, formed in accordance with an embodiment of the present invention.

Corresponding reference characters indicate corresponding parts throughout the several views.

The exemplifications set out herein illustrate embodiments of the invention and such exemplifications are not to be construed as limiting the scope of the invention in any manner.

### DETAILED DESCRIPTION OF THE INVENTION

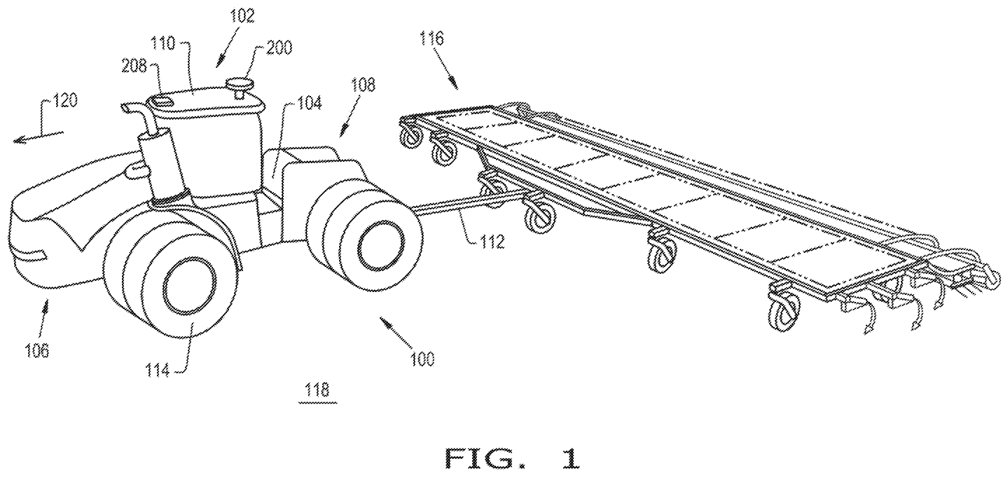

Referring now to the drawings, and more particularly to FIGS. 1-3, systems 100 and 103 are formed in accordance with embodiments of the present invention. A first system 100 (FIG. 1) includes an agricultural vehicle 102 including a chassis 104 having a front portion 106 and a back portion 108. The vehicle 102 includes a cab 110 mounted to the chassis 104. and wheels 114 mounted to the chassis 104. The system 100 may also be configured to couple to an agricultural implement 116 via a tow bar 112, for example. That is, the back portion 108 of the chassis 104 may be configured to couple to the implement 116, although the scope of the invention covers the agricultural implement 116 coupled to the front portion 106 of the chassis 104. As will be discussed more fully below, the system 100 includes a soil roughness (SR) system 200 mounted to the vehicle 102.

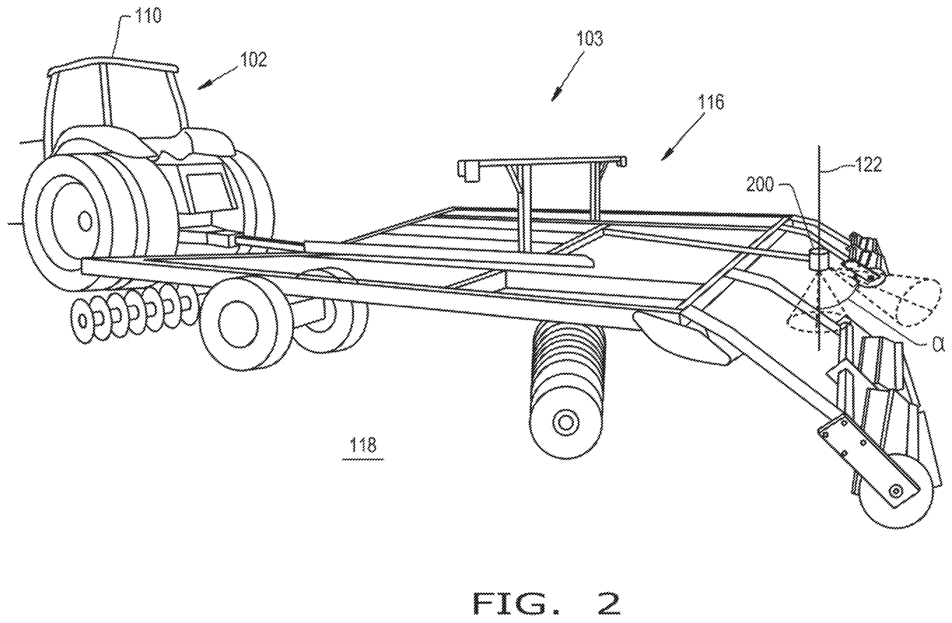

A second system 103 (FIG. 2) includes the agricultural implement 116. In one embodiment of the invention, the agricultural implement 116 is a disk harrow, such as the True-Tandem disk harrow manufactured by Case-IH, that includes one or more rows of disks up front followed by finish wheels at the back. The disks and the finish wheels may be separately controlled for a desired soil finish. In another embodiment, the agricultural implement 116 is a field cultivator (FIG. 1), such as the Tiger-Mate 255 manufactured by Case-IH, that includes multiple bars of tines and a spike tooth drag and finish wheel at the back. Each could be controlled separately for a desired soil finish. However, the agricultural implement may be any type of soil cultivation implement, used to manipulate the soil in sonic manner, including field cultivators, disk harrows, tillers, aeration devices and ploughs, and including implements having tines, disks, blades, rollers or rakes. The agricultural implement116 may either be powered by the vehicle 102 or self-powered. The scope of the present invention covers any soil cultivation implement that is configured to manipulate the soil of the field 118 in sonic manner. As will be discussed more fully below, the system 103 includes the SR system 200 mounted to the agricultural implement 116. Both the agricultural vehicle 102 and the agricultural implement 116 are examples of agricultural machines.

In one embodiment of the invention, the SR system 200 includes at least one radar unit 202 mounted to the agricultural implement 116 or alternatively, to the vehicle 102, an optional actuator system 204 having one or more actuators 206 that may be mounted to the cultivation implement 116, at least one optional GPS device 208 mounted to the vehicle 102, for example to the cab 110, a controller 210 mounted to the cab 110 or integrated with the radar unit 202 and mounted with the radar unit either to the vehicle 102 or to the implement 116, and an output device 212 mounted to the cab 110. The controller 210 and the output device 212 may be integrated together as components of a laptop, a smart phone or a PDA, for example, or may be structurally discrete entities (e.g., the output device 212 may be a monitor). The controller 210 may be communicatively coupled to the radar unit 202, the optional actuator system 204, the optional GPS device 208, and the output display unit 212 via cables 214, 216, 218 and 220, such as Ethernet coaxial cables forming a LAN, or wirelessly via a WLAN, for example. As mentioned above, the controller 210 may be integrated with the radar unit 202. The radar unit 202 including the controller 210 may be mounted to the vehicle 102, for example, to an outside portion of the cab 110, or to the agricultural implement 116.

In an embodiment of the present invention, the controller 210 may include a processor 222, e.g., a microcontroller or a CPU, and a memory 224. The processor 222 is configured to receive radar signals from the radar unit 202 and process the radar signals for determining soil roughness values of the field 118.

In one embodiment of the invention, the radar unit 202 is a Doppler radar unit configured to compute a Doppler signal based upon a shift in the frequency between a signal emitted by the radar unit 202 and a signal received by the radar unit 202, where the signal received by the radar unit 202 is the emitted signal reflected by the field 118 (e.g., by the soil of the field 118). The radar unit 202 is configured to transmit the Doppler signals to the controller 210 via the cable 214 or via other electronic means, such as wirelessly. The processor 222 of the controller 210 is configured to compute soil roughness values in real time based at least upon the received Doppler signals.

For example, in one embodiment the controller 210 is configured to store the received Doppler signals in the memory 224 and the processor 222 is configured to periodically compute a standard deviation of those Doppler signals stored over a predefined and adjustable interval of time and compute a soil roughness value in real time based upon the computed standard deviation of the Doppler signals. In this embodiment, Sᵣ=f(σ_{sd}), where σ_{sd} standard deviation of the Doppler signals S_{d}, and where f(σ_{sd}) may be any function, such as a polynomial, exponential, or logarithmic function, or based upon any empirically-derived relationship between soil roughness values and standard deviation of the Doppler signals as embodied in a table, for example, stored in the memory 224.

For example, as the soil roughness increases, variability of clod size may also increase, and thus one of skill could derive an empirically-based relationship between the standard deviation of the Doppler signals and average clod size and/or standard deviation of average clod size, which could further be quantified as a soil roughness value. More specifically, since the vehicle 102 and thus the radar unit 202 is moving in a forward (i.e., horizontal) direction 120 at a speed v, any non-uniformities in the field 118 (i.e., non-uniformities causing the surface of the field 118, or in other words, the soil, to he non-planar or not flat) would appear to have a vertical component of velocity (i.e., appear to moving away from or towards the radar unit 202) in a reference frame of the vehicle 102. That is, a non-uniform soil surface of the field 118, in combination with a speed of the vehicle 102, will result in relative motion between the radar unit 202 and the surface of the field, thereby resulting in a Doppler signal. A very rough soil surface may have, on average, more variability of clod sizes as well as larger clod sizes that may result in larger frequency shifts between emitted and received signals (i.e., larger Doppler signals) and/or a larger standard deviation of the Doppler signals.

In another embodiment of the invention, the processor 222 may be configured to compute soil roughness values in real time based on the received Doppler signals, and further based upon one or more operating parameters of the radar unit 202 and/or the agricultural vehicle 102. As is known, the Doppler signal S_{d}=(2·vᵣ·fₑ)/c, where fₑ is the frequency of the radar signal emitted by the radar unit 202, vᵣ is the relative speed between the radar unit 202 and an object of the field 118, such as a clod of soil, which is reflecting the emitted signal, and c is the speed of light. In one embodiment of the invention, the relative speed yᵣ is a function of the forward speed v, or in other words, the horizonal speed, of the radar unit 202 (i.e., the forward speed of the agricultural vehicle 102 or the cultivation unit 116 to which the radar unit 202 is mounted) and the roughness of the soil, Sᵣ.

By way of an exemplary illustration only, FIG. 4 shows soil roughness measured as a geometric parameter θ of a clod, according to one embodiment of the invention. That is, for larger average clod sizes, which may represent rougher soil surfaces, a face of a clod, for example, face 402 of clod 404, may be steeper, and the magnitude of the vertical velocity vᵣ of the face 402 relative to the magnitude of the vertical velocity of the radar unit 202 (which may be assumed to he zero), referred to as the relative speed between the radar unit 202 and the clod 404, is vᵣ=tan(θ)·v. Thus, Sᵣ=f(one or more geometric parameters of a soil clod)=f(θ)=f(Arctan(vᵣ/v)=f(Arctan[(c·S_{d})/(2·fₑ·v)]). In this exemplary embodiment, the soil roughness value Sᵣ is a function of the Doppler radar signal S_{d}, the frequency of the emitted signal fₑ, and the speed v of the vehicle 102 (i.e., the speed of the radar unit 202).

In one embodiment of the invention, the speed of the vehicle 102 may be obtained directly from a vehicle speed measurement system (not shown) (i.e., from mechanical or electrical signals from a vehicle speedometer system, for example), or from the optional GPS unit 208. In other embodiments of the invention, when the vehicle 102 has some significant vertical motion resulting from the vehicle 102 traveling in the forward direction 120 over particularly rough terrain, the scope of the invention may include this additional relative vertical motion vᵥ between the radar unit 202 and the soil of the field 118 (e.g., the clod 404) by adding (or subtracting, depending upon the direction of the vertical motion relative to the soil) vᵥ to the above equation for soil roughness. That is, by way of the above-described exemplary embodiment, Sᵣ=f(θ)=f(Arctan(vᵣ±vᵥ/v)=f(Arctan[(c·S_{d})/(2·fₑ·v)±vᵥ/v]). In one embodiment of the invention, the GPS unit 208 is configured to compute and send the additional relative vertical speed vᵥ between the radar unit 202 and the field 118 to the controller 210. In another embodiment of the invention, the SR system 200 may include an accelerometer configured to compute and send the additional relative vertical speed vᵥ between the radar unit 202 and the field 118 to the controller 210.

In another embodiment of the invention, the relative speed vᵣ between the radar unit 202 and the field 118 is a function of the speed v of the vehicle 102 and one or more clod parameters ϕ₁, ϕ₂, . . . ϕₙ, representing the shape or geometry of average clods of the soil, such as one or more slope angles θ, as discussed above, sphericity of an average clod, size of an average clod (e.g., based upon an average diameter), etc. In other words, in one embodiment, vᵣ=f)(ϕᵢ, v), i=1,n. Thus, vᵣ=(c·S_{d})/(2·fₑ)=f(ϕᵢ, v), which can be solved for the one or more clod parameters ϕᵢ, using one or more measured Doppler signals S_{d}, that represent average clod geometries, which can then be mapped by any predetermined mapping function to a soil roughness value Sᵣ. For example, a predetermined mapping function may be in the form Sᵣ=F(ϕ₁, ϕ₂, . . . ϕₙ).

The functions f(ϕ₁, ϕ₂, . . . ϕₙ, v), i=1, n and F(ϕ₁, ϕ₂, . . . ϕₙ) include any functions, for example polynomial functions of any degree or empirically-derived relationships that map geometric properties of the soil (e.g., geometric properties of average clods) and the speed v to relative velocities between the radar unit 202 and the soil of the field 118, and map the geometric properties of the soil (e.g., geometric properties of average clods) to soil roughness values, respectively, as tabulated in one or more tables, for example, stored in the memory 224.

in another embodiment of the invention, the soil roughness value Sᵣ is a function of the Doppler signal S_{d}, and one or more of the following variables: one or more clod parameters of an average clod of soil, ϕᵢ, i=1, n; the speed v of the vehicle 102, the vertical speed of the radar unit vᵥ, and the frequency of the emitted radar signal fₑ. The function(s) may be empirically derived based upon experimentally-derived correlations between the Doppler signals and the one or more variables listed above with soil roughness Sᵣ values obtained via measurements, including but not limited to the number of clods having sizes in certain ranges per unit area of soil and/or changes in a horizontally-measured length of a chain when placed on uneven or rough soil.

In another embodiment of the invention, the controller 210 may send the computed soil roughness values to the output device 212 as they are generated, for display and viewing by the operator of the vehicle 102, and/or the controller 210 may store the soil roughness values in the memory 224 as they are generated as the vehicle 102 moves across the field 118. The processor 222 may compute average soil roughness values based upon the stored soil roughness values accumulated and stored over predetermined and adjustable time intervals.

The controller 210 may also send the average soil roughness values to the output device 212 for display.

In an embodiment of the invention, the output device 212 may be the screen of a laptop, a smart phone or a personal digital assistant (PDA), or a display or a monitor, for example.

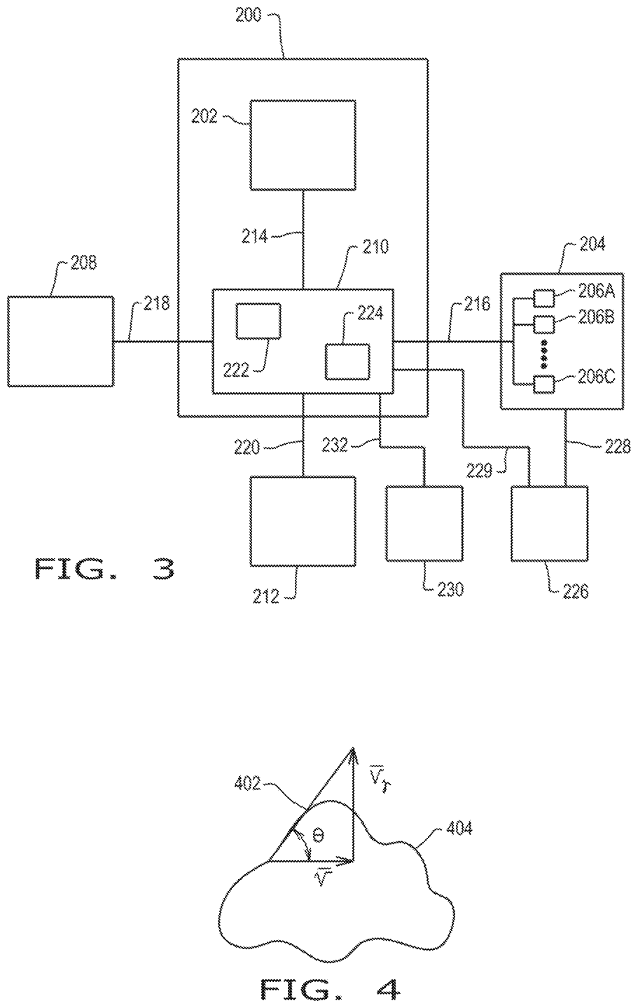

In another embodiment of the invention, an operator of the vehicle 102 may adjust properties of the agricultural implement 116 via one or more actuators 206 of the actuator system 204 based on the computed soil roughness values Sᵣ. For example, and as illustrated in FIG. 3, an actuator control panel 226 may be mounted to the vehicle 102, for example to the cab 110, and communicatively coupled to the actuator system 204 and the controller 210 either wirelessly or via a cable 228 and a cable 229. respectively. The operator may adjust a depth at which tines, disks or blades of the agricultural implement 116 processes the soil of the field 118 via control of actuator 206A through control signals generated by the actuator control panel 226. The operator may also use the actuator control panel 226 to generate control signals that may, for example, adjust a number of disks of a disk harrow 116 that engage the soil via an actuator 206B, or adjust an angle at which the tines, disks or blades of the agricultural implement 116 engage the soil with respect to the forward direction 120 of the vehicle 102. Each of actuators 206 of the actuator system 204 may comprise pistons, levers, switches, hoses, and corresponding electronics that are driven or activated pneumatically, hydraulically, or electrically via operation of the actuator control panel 226 by the operator.

In another embodiment of the invention, an operator inputs to the controller 210, via an input device 230 and a cable 232 (or wirelessly), a predetermined desired soil roughness value. The input interface 230 may be, for example, a keyboard, a mouse, or a touch pad, either integrated with the controller 210 or configured as a separate entity. The input device may also be a laptop or a smart phone enabling a user to store data or controller instructions in the memory 224, and to extract data from the memory 224. Furthermore, the controller 210 is configured to compare the desired soil roughness value with one or more of the computed soil roughness values, and based upon the comparison, generate and send electrical control signals to one or more of the actuators 206 via the actuator control panel 226 for automatically adjusting properties of the agricultural implement 116 to generate the desired soil roughness value, without any operator input.

In one embodiment of the invention, and as illustrated in FIG. 2, one or more radar units 202 of the SR system 200 are adjustably (e.g., rotatably) mounted to the agricultural implement 116. such that the emitted signals are directed either downward.

with respect to a vertical direction 122 (i.e., α=0°), or directed at some non-zero angle α with respect to the vertical direction 122, thereby emitting radar signals to intersect the processed or otherwise cultivated field 118 behind the agricultural unit 116. When the radar unit 202 is looking vertically downward (i.e., α=0°), the radar's resolution is at its largest, although the surface area covered by the radar unit 202 is at its smallest, however, as the radar unit 202 is adjusted to look in the backward direction. (e.g., α=45°), the surface area of the field 118 covered by the radar unit 202 increases although the resolution decreases. In another embodiment, the radar unit 202 of the SR system 200 is mounted to the vehicle 102, for example on top of the cab 110, and is configured to emit signals in a backward direction for being reflected by that portion of the field 118 behind the agricultural implement 116 that has been cultivated.

In another embodiment of the invention, two or more radar units 202 are mounted to the cultivation implement 116, with one or more first radar units mounted for emitting radar signals towards portions of the soil that have not yet been processed by the agricultural implement 116 (e.g., directed in the forward direction 120), and with one or more second radar units 202 mounted for emitting radar signals towards portions of the soil that have presently been processed by the agricultural implement 116 (e.g., directed in a direction opposite the forward direction 120). This embodiment enables the system to adjust (either manually via the operator or automatically via the controller 210) properties of the cultivation implement 116 based upon soil roughness values acquired via the first radar unit before the field 118 is processed by the agricultural implement 116 in order to pre-adjust the agricultural implement 116 for a desired soil (or field) roughness, and also compare the soil roughness values obtained by the second radar unit with the desired soil roughness values to determine if the agricultural implement 116 has been adjusted properly, and if not, enable the system 200 via either the operator or the controller 210 make further adjustments to the properties of the agricultural implement 116.

In yet another embodiment of the invention, the radar unit 202 is a polarimetric radar unit. A polarimetric radar unit emits a polarized signal (e.g., left-hand circularly or right-hand circularly polarized). For example, a polarimetric radar unit may emit a LHC polarized signal as a series of pulses and may receive signals reflected one or more times from an object in the field 118 (e.g., a clod). If the soil is very smooth, then most received signals will have the same polarization as the emitted signals (e.g., LHC polarized in the present example), however, if the soil is very rough, there will be a wider range of angles of incidence of the emitted signals with the objects of the field 118, and since signals may change their polarization upon reflection, based at least upon the angles of incidence of the signals with the soil, there will be a greater percentage of reflected signals received by the radar unto 202 that have a change in polarization (i.e., for very rough surfaces, up to approximately half of the received reflected signals (i.e., half of the received energy) will be in the form of LHC polarized waves and approximately half of the received reflected signals (i.e., half of the received energy) will be in the form of RHC polarized waves). Thus, in one embodiment of the invention, soil roughness values Sr may be based upon a change in the polarization of the emitted signals as measured in the received signals and/or based on the change of signal energy emitted to signal energy received, since for a very rough surface, less energy will be received by per unit area of soil. In one embodiment, the polarimetric radar unit 202 sends radar signals to the controller 210. The radar signals include polarization information, for example, an amount of change in the polarization of the emitted signals measured based on a comparison of polarization (or polarization distribution) of the emitted signals to the polarization (or polarization distribution) of the received reflected signals.

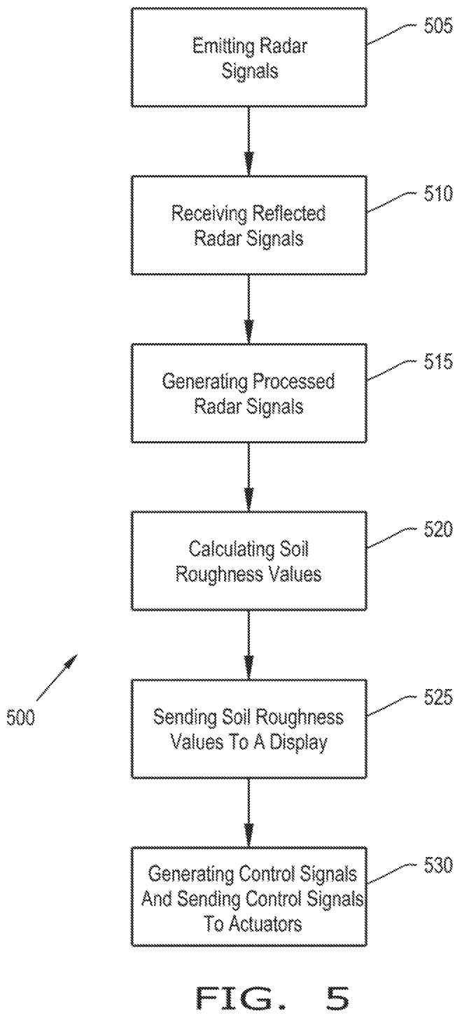

FIG. 5 is a flow chart illustrating a soil roughness measurement method 500, according to an embodiment of the present invention. In step 505, the radar unit 202 emits signals that are reflected by the field 118. For example, the signals may be reflected from portions of the field 118 that has yet to be processed by the agricultural implement 116 and/or the radar signals may be reflected from portions of the field 118 that have presently been processed by the agricultural implement 116. In one embodiment, processing the field 118 by the agricultural implement includes physically manipulating or cultivating the soil of the field 118 in some manner.

In step 510, the radar unit 202 receives the reflected signals, and in step 515, based at least upon the received reflected signals, generates the radar signals (e.g., Doppler radar signals if the radar unit is a Doppler radar unit and radar signals conveying polarization information, such as a change in the polarization of the emitted radar signals for a polarimetric radar unit). The controller sends the radar signals (e.g., the Doppler radar signals or the polarimetric radar signals) to the controller 210.

In step 520, the controller 210 calculates the soil roughness values. Depending upon the type of radar unit 202, for example a Doppler radar unit or a polarimetric radar unit, the soil roughness values may be based upon a standard deviation of the Doppler signals, or upon a function of one or more of Doppler signal values, relative speed of the radar unit with respect to the field and frequency of the emitted Doppler signals, or based upon a change in the polarization of the emitted polarimetric signals.

In optional step 525, the controller 210 sends the soil roughness values to the output device 212 for display. In response to the displayed soil roughness values, an operator of the vehicle 102 may seek to adjust properties of the cultivation implement 116 via activating one or more actuators 206 of an actuator system 204 via an actuator control panel 226. The actuators 206 may be connected to various components of the cultivation implement 116, and may be configured, via electrical signals or pneumatic or hydraulic flows, collectively referred to as control signals, initiated by the actuator control panel, to adjust various properties, such as the number of tines or blades engaging the soil, a depth to which the tines or blades engage the soil, and/or angles (e.g., harrow angles) at which the tines or blades engage the soil, etc. Alternatively, the operator may replace the present agricultural implement 116 with a different agricultural implement, based upon the soil roughness values.

In optional step 530, the controller 210 compares a predetermined desired soil roughness value, stored for example in the memory 224, or input to the controller 222 by an operator via the input device 226, with the generated soil roughness values, and based upon this comparison, automatically, and independent of the operator of the vehicle 102, generates one or more electrical control signals. The controller 222 sends the electrical control signals to the actuator control unit 226 for controlling the one or more actuators 206 of the actuator system 204 accordingly. The actuators 206 may be connected to various components of the agricultural implement 116, and may be configured, via. electrical signals or pneumatic or hydraulic flows, collectively referred to as control signals generated by the actuator control unit 226 in response to receiving the electrical control signals from the controller 222, to adjust various components and/or properties of the agricultural implement 116 as described above for directing the agricultural unit 116 to process the soil to have the desired soil roughness.

It is to be understood that the steps of the method 500 are performed by the controller 210, or respective components of the controller 210, such as the processor 222, upon loading and executing software code or instructions which are tangibly stored on a tangible computer readable medium, such as on a magnetic medium, e.g., a computer hard drive, an optical medium, e.g., an optical disc, solid-state memory, e.₂., flash memory, or other storage media known in the art. Thus, any of the functionality performed by the controller 210 described herein, such as the method 500, is implemented in software code or instructions which are tangibly stored on a tangible computer readable medium, Upon loading and executing such software code or instructions by the controller 210, the controller 210 may perform any of the functionality of the controller 210 described herein, including any steps of the method 500 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

While this invention has been described with respect to at least one embodiment, the present invention can be further modified within the scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An agricultural machine, comprising
an agricultural implement having a rear end; and
a soil roughness system mounted to the agricultural implement, comprising:
at least one radar unit configured to emit signals, receive reflected signals and generate radar signals; and
a controller communicatively coupled to said at least one radar unit,
wherein:
said at least one radar unit is a Doppler radar unit or a polarimetric radar unit that is mounted onto the rear end of the agricultural implement and emits said emitted signals onto a surface of a field, behind the agricultural implement, said field comprises clods of soil, and said reflected signals being said emitted signals reflected from the clods of soil in the field such that a change in said reflected signals relative to the emitted signals is caused by the clods of soil, and
said controller generates soil roughness values of said field based at least upon said change between said emitted signals and said reflected signals, wherein said controller or an operator of said machine adjusts properties of the agricultural implement (based upon said soil roughness values.

2. The agricultural machine according to claim 1, wherein said at least one radar unit is the Doppler radar unit, and wherein said radar signals are Doppler radar signals.

3. The agricultural machine according to claim 2, wherein said generated soil roughness values are based upon a standard deviation of said Doppler radar signals.

4. The agricultural according to claim 2, wherein said generated soil roughness values are based upon said Doppler radar signals, a speed of said agricultural machine relative to said field and a frequency of said emitted signals.

5. The agricultural machine according to claim 2, wherein said generated soil roughness values are based upon said Doppler radar signals, a speed of said agricultural machine relative to said field, a frequency of said emitted signals, and one or more geometric parameters of an average clod of soil of said clods of soil.

6. The agricultural machine according to claim 1, wherein said at least one radar unit is the polarimetric radar unit.

7. The agricultural machine according to claim 6, wherein said change between said emitted signals and said reflected signals represents a change in a polarization of said emitted signals and/or an energy difference between said emitted signals and said received reflected signals, said change in said polarization of said emitted signals based at least upon a polarization distribution of said emitted signals and a polarization distribution of said received reflected signals.

8. The agricultural machine according to claim 7, wherein said polarization of said emitted signals is a circular polarization.

9. The agricultural machine according to claim 1, wherein the agricultural machine comprises an agricultural vehicle, and wherein said agricultural vehicle further comprises:
an output device communicatively coupled to said controller, said output device configured to receive and display said soil roughness values; and
an actuator control panel, said actuator control panel communicatively coupled to said controller and to one or more actuators of said agricultural implement coupled to said agricultural vehicle, said one or more actuators configured for receiving control signals and adjusting said properties of said agricultural implement based on said received control signals, said actuator control panel configured to generate said control signals via the operator of said vehicle based upon said soil roughness values.

10. The agricultural machine according to claim 9, wherein said controller further comprises a memory and a processor configured to generate said soil roughness values based at least upon said radar signals, wherein
said agricultural vehicle further comprises an input device communicatively coupled to said controller, said controller configured to receive a predetermined desired soil roughness value via said input device, said memory configured to store said desired soil roughness, wherein
said processor is further configured to compare said generated soil roughness values with said desired soil roughness value and generate electrical control signals based upon said comparison, and wherein
said actuator control panel is further configured to receive said electrical control signals and generate additional control signals based upon the received electrical control signals.

11. The agricultural machine according to claim 1, wherein the agricultural machine comprises an agricultural vehicle, said agricultural implement including one or more actuators, wherein
said agricultural implement is coupled to said agricultural vehicle, said agricultural vehicle including an output device and an actuator control panel, wherein
said controller is communicatively coupled to said output device and said actuator control panel, said output device configured to receive and display said soil roughness values, and wherein
said actuator control panel is communicatively coupled to said one or more actuators, said one or more actuators configured for receiving control signals and adjusting said properties of said agricultural implement based on said received control signals, said actuator control panel configured to generate said control signals via the operator of said vehicle based upon said soil roughness values.

12. The agricultural machine according to claim 11, wherein said controller further comprises a memory and a processor configured to generate said soil roughness values based at least upon said radar signals, wherein
said agricultural vehicle further comprises an input device communicatively coupled to said controller, said controller configured to receive a predetermined desired soil roughness value via said input device, said memory configured to store said desired soil roughness, wherein
said processor is further configured to compare said generated soil roughness values with said desired soil roughness value and generate electrical control signals based upon said comparison, and wherein
said actuator control panel is further configured to receive said electrical control signals and generate additional control signals based upon the received electrical control signals.
